(19) United States
(12) Patent Application Publication
(10) Pub. No.: US 2016/0241101 A1
(43) Pub. Date: Aug. 18, 2016

(54) MOTOR AND ROBOT

(71) Applicant: Seiko Epson Corporation, Tokyo (JP)

(72) Inventor: Shinji YASUKAWA, Shiojiri (JP)

(21) Appl. No.: 15/043,754

(22) Filed: Feb. 15, 2016

(30) Foreign Application Priority Data
Feb. 18, 2015 (JP) 2015-029303

(51) Int. Cl. H02K 3/32; H02K 3/28

(52) U.S. Cl. CPC H02K 3/325; H02K 3/28; H02K 2203/12

(57) ABSTRACT

In order to prevent insulation failure of a motor and a robot, the motor includes a stator core, plural bobbins mounted on the stator core and provided with flange parts, and a winding wound around each of the bobbins, in which a space of a gap between plural flange parts adjacent to each other is smaller than a diameter of the winding.

### BACKGROUND

1. Technical Field

The present invention relates to a motor and a robot.

2. Related Art

When a stator of an electromotor (motor) is configured, a winding is wound around a bobbin, and then, a predetermined number of the bobbins are mounted on a laminated core. Finally, the laminated core on which the bobbins are mounted is inserted in an injection mold, and a sheath protection insulating layer is resin-molded under predetermined pressure and heat. In this process, the winding positioned at the winding outermost surface part of the bobbin may be peeled off from the surface by the pressure and heat, and the winding may protrude from a space between the adjacent bobbins by the pressure and may approach the laminated core. This may cause insulation failure.

On this issue, a manufacturing method of a stator assembly is disclosed in which a winding is coiled around a resin bobbin mounted on a salient pole of a laminated core, and these are coated with an sheath protection insulating layer (see, for example, Patent Literature 1 (JP-A-2005-143206)). A technique is disclosed in which a gap between the stator assembly and a cavity for injection molding of the sheath protection insulation layer is regulated in order to reduce the deformation of the bobbin in the manufacturing process of coating the stator assembly.

However, there is also a problem of movement of the winding in addition to the deformation of the bobbin by the injection pressure disclosed in Patent Literature 1.

### SUMMARY

An advantage of some aspects of the invention is to solve at least part of the problems described above and the invention can be implemented as following forms or application examples.

### Application Example 1

A motor according to this application example includes a stator core, plural bobbins mounted on the stator core and provided with flange parts, and a winding wound around each of the bobbins, in which a space of a gap between the plural flange parts adjacent to each other is smaller than a diameter of the winding.

According to this application example, both ends of the flange part of the bobbin are extended, and the space of the gap between the adjacent flange parts is made smaller than at least the single wire diameter of the winding. Hereby, the protrusion of the winding from the space of the gap between the adjacent flange parts can be prevented. Accordingly, the motor in which insulation failure is prevented can be provided.

### Application Example 2

In the motor according to the application example, it is preferable that the space of the gap is more than 0.2 mm and smaller than 0.3 mm.

According to this application example, the protrusion of the winding from the space of the gap between the adjacent flange parts can be prevented.

### Application Example 3

In the motor according to the application example, it is preferable that the gap between the plural flange parts adjacent to each other has a shape bent with respect to a radial direction of the stator core.

According to this application example, the protrusion of the winding from the space of the gap between the adjacent flange parts can be prevented.

### Application Example 4

In the motor according to the application example, it is preferable that the gap between the plural flange parts adjacent to each other has a shape widening in a radial direction of the stator core.

According to this application example, the protrusion of the winding from the space of the gap between the adjacent flange parts can be prevented. Incidentally, the gap is desirably formed such that the space widens toward the outside in the radial direction of the stator core.

### Application Example 5

A robot according to this application example includes the motor described in any one of the application examples set forth above.

According to this application example, the highly reliable robot can be provided.

### BRIEF DESCRIPTION OF THE DRAWINGS

The invention will be described with reference to the accompanying drawings, wherein like numbers reference like elements.

FIG. 1 is a sectional view showing a motor according to a first embodiment.

FIGS. 2A and 2B are views showing a structure of a stator according to the first embodiment, in which FIG. 2A shows fitting of bobbins to teeth, and FIG. 2B shows fitting of a yoke.

FIG. 3 is a view showing the shape of a gap between plural flange parts adjacent to each other according to the first embodiment.

FIG. 4 is a view showing the shape of a gap between plural flange parts adjacent to each other according to a second embodiment.

FIGS. 5A and 5B are views showing the shape of a gap between plural flange parts adjacent to each other according to modifications, in which FIG. 5A shows a shape obliquely crossing the radial direction of a stator core, and FIG. 5B shows a shape widening in the radial direction of the stator core.

FIG. 6 is a perspective view showing a robot to which a motor according to the embodiment is applied.

FIG. 7 is a perspective view showing a robot to which a motor according to the embodiment is applied.

### DESCRIPTION OF EXEMPLARY EMBODIMENTS

Hereinafter, embodiments of a motor embodying the invention will be described with reference to the drawings. Incidentally, the drawings are appropriately enlarged or reduced so that portions to be described can be recognized.

### First Embodiment

### Motor

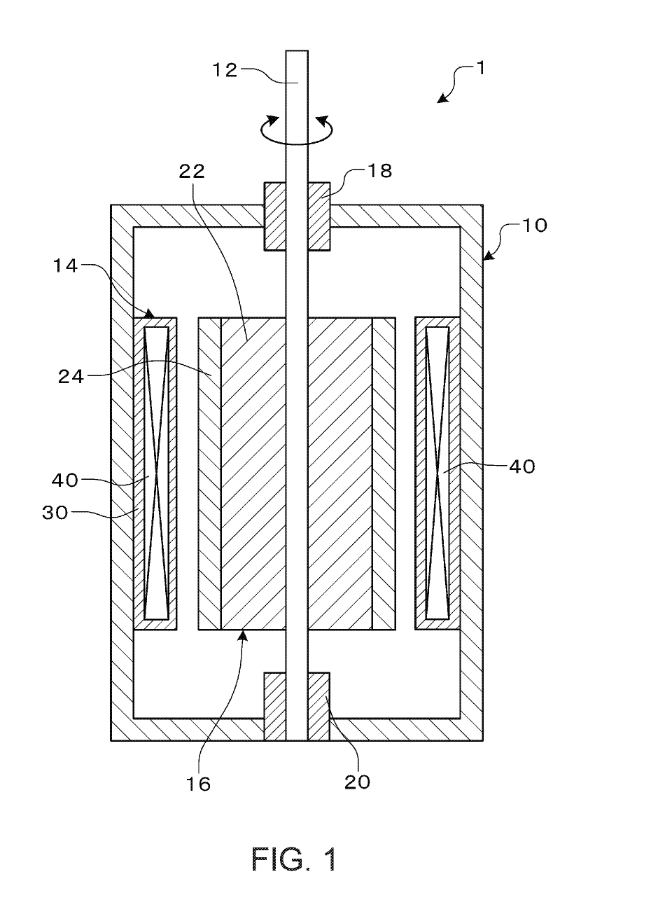

FIG. 1 is a sectional view showing a motor according to an embodiment.

As shown in FIG. 1, the motor 1 according to the embodiment includes a housing 10, a rotation shaft 12, a stator and a rotor 16. Incidentally, the motor 1 is not particularly limited, and may be, for example, a servo motor, a stepping motor or the like.

Bearings 18 and 20 are provided on an upper wall and a bottom wall of the housing 10. The rotation shaft 12 is rotatably supported on the bearings 18 and 20. The rotor 16 is fixed to the rotation shaft 12 in the housing 10. The rotor 16 is cylindrical and includes a core 22 made of a soft magnetic material such as iron and a permanent magnet 24 provided on the outer periphery of the core 22. Besides, the stator 14 is disposed around the rotor 16. The material of the housing 10 is, for example, a conductive metal. The permanent magnet 24 has a circular cylindrical shape. Besides, the permanent magnet 24 has a multi-polar structure in which plural magnetic poles are formed in the circumferential direction thereof.

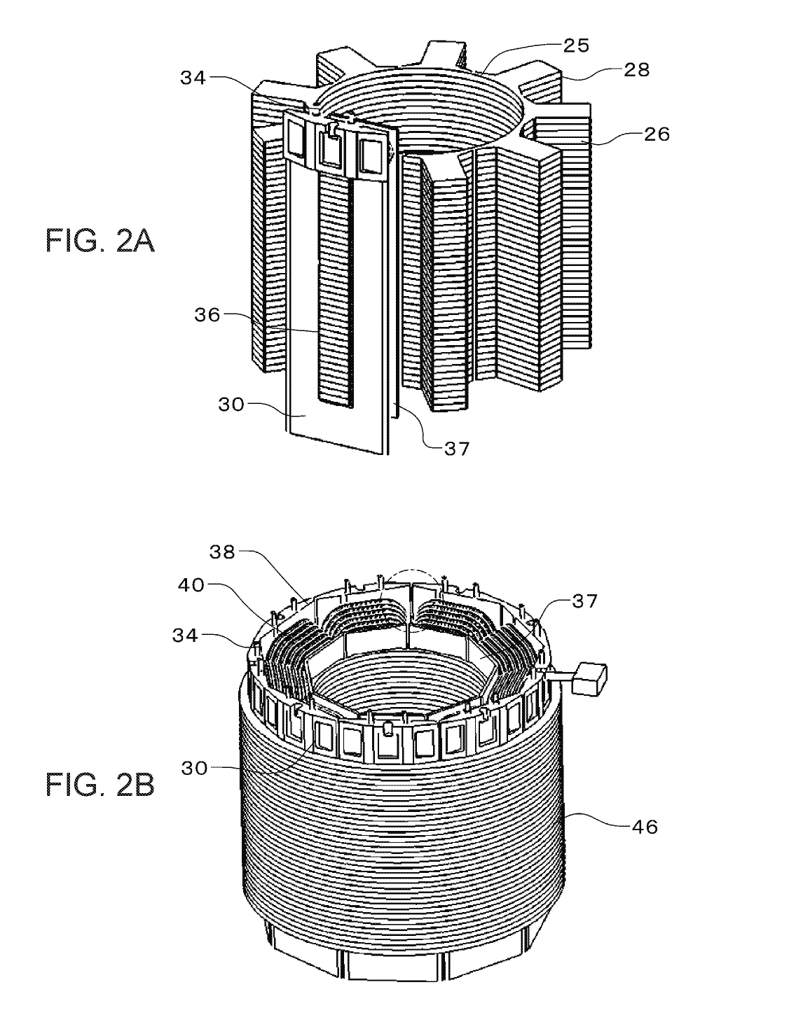

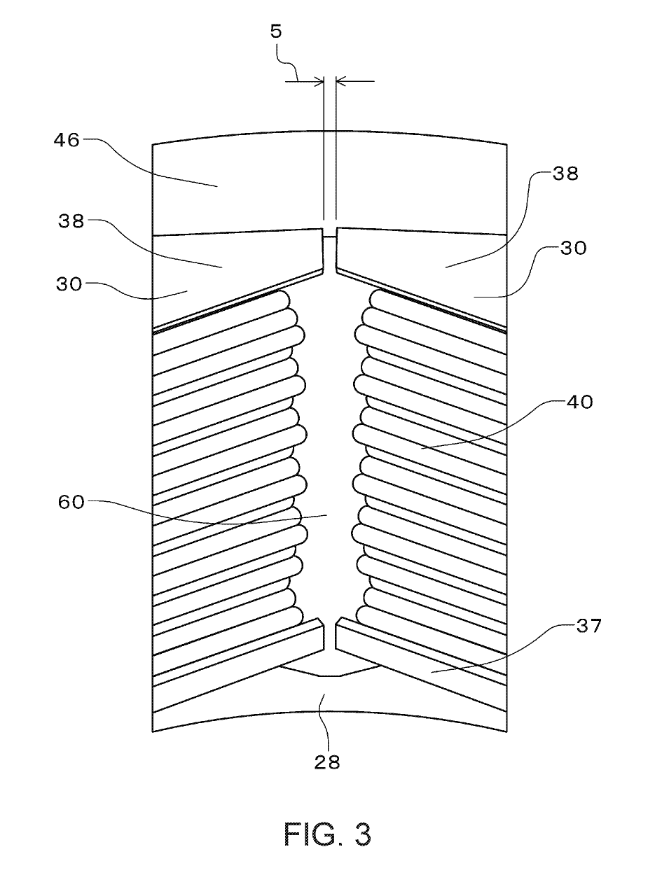

FIGS. 2A and 2B are views showing a structure of the stator 14 according to the embodiment. FIG. 2A shows fitting of bobbins 30 to teeth 26, and FIG. 2B shows fitting of a yoke 46. FIG. 3 is a view showing a shape of a gap 5 between plural second flange parts 38 adjacent to each other according to the embodiment. Incidentally, FIG. 3 is an enlarged view of a region indicated by a circle in FIG. 2B. Besides, FIG. 3 additionally shows the yoke 46 and a mold part 60.

The stator 14 includes a stator core 28 having plural teeth 26 arranged in a circumferential direction relative to an axial line, the tubular bobbins 30 assembled to the outside of the teeth 26 in a radial direction, a winding 40 wound around the teeth 26 through the bobbin 30, a pair of pins 34 around which each of ends of the winding 40 is twined, and the mold part 60 covering the bobbins 30, the winding 40 and the pins 34. The stator core 28 includes an annular part 25 formed into an annular shape, and the plural teeth 26 extending in the radial direction from the annular part 25.

The bobbin 30 includes a tubular core part 36 covering the outer peripheral surface of the teeth 26, and first and second flange parts 37 and 38 extending in the radial direction on both ends of the core part 36. The bobbin 30 is provided outside the teeth 26, and includes the tubular core part 36 around which the winding 40 is wound, the first flange part 37 extending to the inside in the radial direction from the core part 36, and the second flange part 38 extending to the outside in the radial direction from the core part 36. The pins 34 are fixed to the second flange part 38. The second flange part 38 of the bobbin 30 is provided to be continuous with the core part 36.

A space of the gap 5 between the plural second flange parts 38 adjacent to each other according to the embodiment is smaller than a diameter of the winding 40.

The space of the gap 5 is preferably larger than 0.2 mm and smaller than 0.3 mm. For example, when the diameter of the winding 40 is 0.286 mm, the gap 5 is the space smaller than 0.286 mm. According to this, the protrusion of the winding 40 from the space of the gap 5 between the adjacent second flange parts 38 and 38 can be prevented. Besides, when the diameter of the winding 40 is 0.416 mm, the gap 5 is the space smaller than 0.416 mm.

However, when the space of the gap 5 is smaller than 0.2 mm, the stator core 28 and the bobbin 30 can not be assembled. Thus, the space of the gap 5 is required to be 0.2 mm or more.

The bobbin 30 can be formed by using a material having insulation, such as an insulating synthetic resin. The bobbin 30 is molded by injection molding of PPS resin or the like. Incidentally, in addition to the PPS resin, Noryl, PA (polyamide), PBTP (polybutylene terephthalate), PETP (polyethylene terephthalate) or PC (polycarbonate) may be used as the material of the bobbin 30.

Both a thermoplastic resin and a thermosetting resin, such as BMC (unsaturated polyester) resin, PPS (polyphenylene sulfide) resin, phenol resin, melamine resin, urea resin and LCP (liquid crystal polymer) resin, can be used as the material of the mold part 60. A resin having high heat resistance and filled with heat-conductive filler is preferably used. As the filler, a metal material can also be used in addition to a ceramic such as alumina or silica.

According to the embodiment, both ends of the second flange parts 38 and 38 of the bobbins 30 are extended, and the space of the gap 5 between the adjacent second flange parts 38 and 38 is made smaller than, at least, the diameter of the winding 40. Hereby, the protrusion of the winding 40 from the space of the gap 5 between the adjacent second flange parts 38 and 38 can be prevented. Accordingly, the motor 1 in which insulation failure is prevented can be provided.

### Second Embodiment

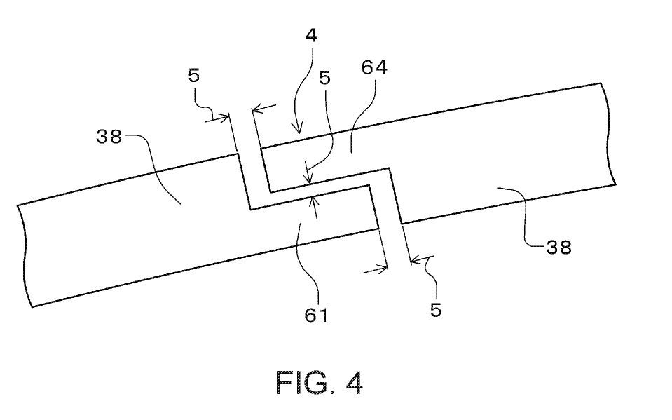

FIG. 4 is a view showing a shape of a gap 5 between plural second flange parts 38 adjacent to each other according to the embodiment. Incidentally, FIG. 4 shows the adjacent second flange parts 38 of bobbins 30, and a winding 40 wound around the bobbin 30 and the like are omitted.

The gap 5 between the plural second flange parts 38 adjacent to each other has the shape bent with respect to a radial direction of a stator core 28. According to this, the protrusion of the winding 40 from the space of the gap 5 between the adjacent second flange parts 38 and 38 can be prevented.

For example, as shown in FIG. 4, in a state where the bobbins 30 are inserted to plural teeth 26, an overlap part 4 is formed between the adjacent bobbins 30 and 30, in which a first projection part 61 and a second projection part 64 adjacent to each other overlap each other in the radial direction of the stator core 28.

That is, the first projection part 61 and the second projection part 64 are positioned alternately with each other, and overlap each other in the radial direction of the stator core 28, so that the overlap part 4 is formed. The gap 5 is formed between the second flange parts 38 and 38 butted against each other in the overlap part 4. That is, the gap 5 which is a space bent in a sectional view is formed between the first projection part 61 and the second projection part 64.

The space of the gap 5 of the overlap part 4 and the space of the gap 5 on both sides of the overlap part 4 may be different from each other as shown in FIG. 4. Hereby, the size of the space of the gap 5 on both the sides of the overlap part 4 can be easily adjusted. Alternatively, the space of the gap 5 of the overlap part 4 can be made large. Besides, the space of the gap 5 of the overlap part 4 and the space of the gap 5 on both the sides of the overlap part 4 may be same.

### Modifications

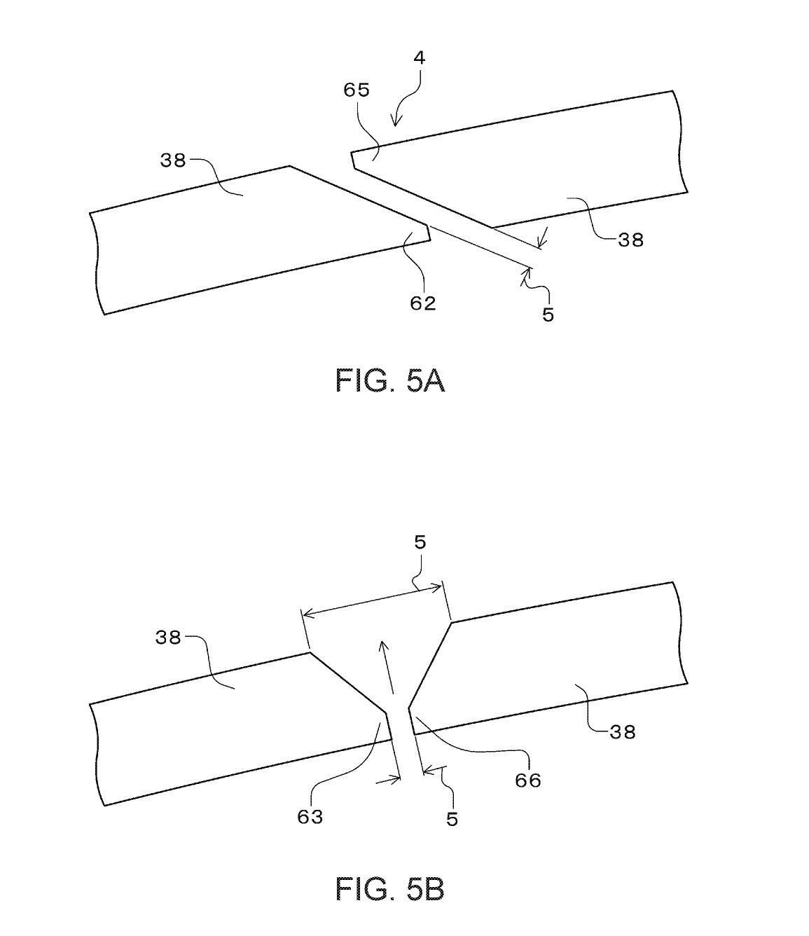

FIGS. 5A and 5B are views each showing a shape of a gap 5 between plural second flange parts 38 adjacent to each other according to modifications. FIG. 5A shows the shape obliquely crossing the radial direction of the stator core 28. FIG. 5B shows the shape widening in the radial direction of the stator core 28. Incidentally, FIGS. 5A and 5B show the adjacent second flange parts 38 of the bobbin 30, and the winding 40 wound around the bobbin 30 and the like are omitted.

As shown in FIG. 5A, the shape of the gap 5 between the plural second flange parts 38 adjacent to each other is preferably the shape obliquely crossing the radial direction of the stator core 28. According to this, the protrusion of the winding 40 from the space of the gap 5 between the adjacent second flange parts 38 and 38 can be prevented.

That is, a first projecting part 62 and a second projecting part 65 are positioned alternately with each other, and overlap each other in the radial direction of the stator core 28, so that the overlap part 4 is formed. The gap 5 is formed between the second flange parts 38 and 38 butted against each other in the overlap part 4. That is, the gap 5 which is the bent space in a sectional view is formed between the first projecting part 62 and the second projecting part 65. According to this, the path of the gap 5 can be made long.

Besides, as shown in FIG. 5B, the shape of the gap 5 between the plural second flange parts 38 adjacent to each other preferably widens in the radial direction of the stator core 28. According to this, the protrusion of the winding 40 from the space of the gap 5 between the adjacent flange parts 38 and 38 can be prevented. Incidentally, the gap 5 is desirably formed such that the space widens toward the outside in the radial direction of the stator core 28.

That is, the space of the gap 5 between the first projecting part 63 and the second projecting part 66 adjacent to each other is smaller than the diameter of the winding 40. The gap 5 is formed such that the space widens toward the outside in the radial direction (arrow direction in FIG. 5B) of the stator core 28. According to this, when the mold part 60 (see FIG. 3) is formed, resin can be easily injected.

### Robot

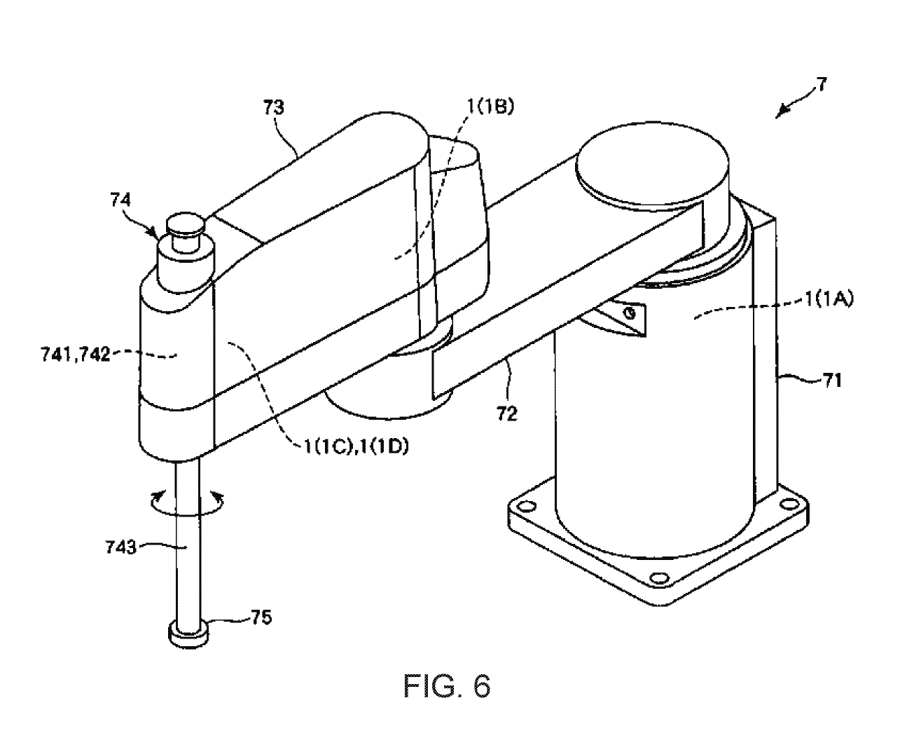

FIG. 6 is a perspective view showing a robot 7 to which the motor 1 of the embodiment is applied.

Next, the robot to which the motor 1 is applied will be described. Incidentally, a horizontal articulated robot and a vertical articulated robot are described as an example of the robot, the robot is not limited to these, and may be a double arm robot or another multiaxial robot.

As shown in FIG. 6, the robot 7 according to the embodiment is a horizontal articulated robot. The robot 7 includes a base 71, a first arm 72, a second arm 73, a working head 74 and an end effector 75.

The base 71 is fixed to, for example, a not-shown floor surface by a bolt. The first arm 72 is connected to an upper end of the base 71. The first arm 72 is rotatable around a rotation axis along the vertical direction relative to the base 71. A motor 1 (1A) for rotating the first arm 72 is installed in the base 71.

The second arm 73 is connected to a tip of the first arm 72. The second arm 73 is rotatable around a rotation axis along the vertical direction relative to the first arm 72. A motor 1 (1B) for rotating the second arm 73 is installed in the second arm 73.

The working head 74 is disposed at a tip of the second arm 73. The working head 74 includes a spline nut 741 and a ball screw nut 742, which are coaxially disposed at the tip of the second arm 73, and a spline shaft 743 inserted into the spline nut 741 and the ball screw nut 742. The spline shaft 743 is rotatable relative to the second arm 73 around an axis thereof and can move (rise and fall) in an up-and-down direction.

A motor 1 (1C) and a motor 1 (1D) are disposed in the second arm 73. The driving force of the motor 1C is transmitted to the spline nut 741 by a not-shown driving force transmission mechanism. When the spline nut 741 rotates forward and backward, the spline shaft 743 rotates forward and backward around the rotation axis along the vertical direction. On the other hand, the driving force of the motor 1D is transmitted to the ball screw nut 742 by a not-shown driving force transmission mechanism. When the ball screw nut 742 rotates forward and backward, the spline shaft 743 moves up and down.

The end effector 75 is connected to the tip (lower end) of the spline shaft 743. The end effector 75 is not particularly limited, and may be, for example, such as to hold a conveyed object or such as to process a workpiece. According to this, the robot 7 having the effects of the motor 1 described above can be provided. Besides, the highly reliable robot 7 can be provided.

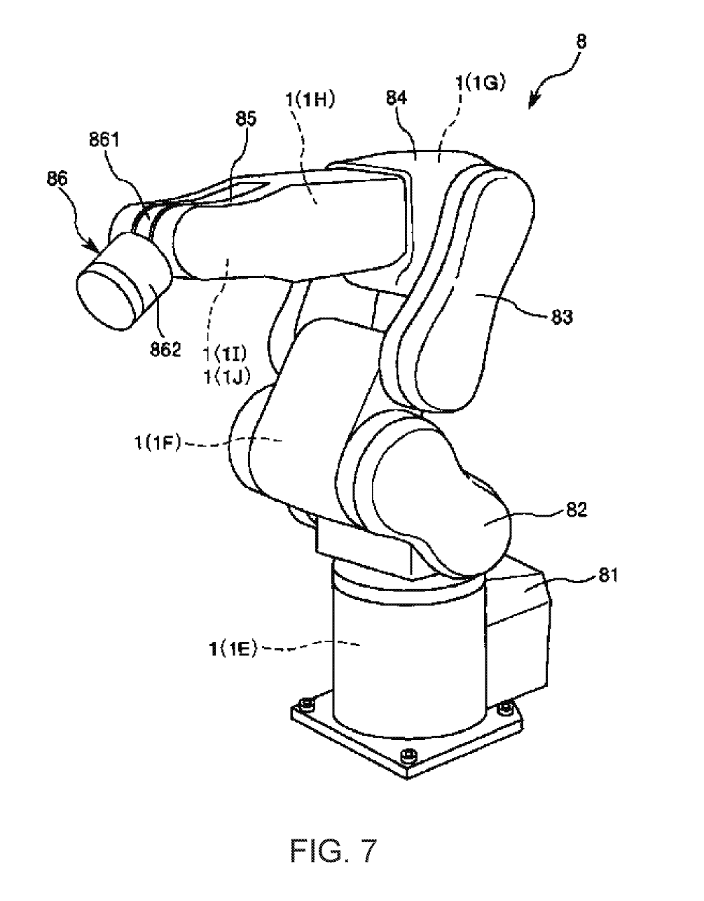

FIG. 7 is a perspective view showing a robot 8 to which the motor 1 according to the embodiment is applied.

As shown in FIG. 7, the robot 8 of the embodiment is a vertical articulated (six axes) robot. The robot 8 includes a base 81, four arms 82, 83, 84 and 85, and a wrist 86, and these are sequentially connected.

The base 81 is fixed to, for example, a not-shown floor surface by a bolt or the like. The arm 82 is connected to an upper end of the base 81 in an inclined posture relative to the horizontal direction. The arm 82 is rotatable around a rotation axis along the vertical direction relative to the base 81. Besides, a motor 1 (1E) for rotating the arm 82 is installed in the base 81.

The arm 83 is connected to a tip of the arm 82, and the arm 83 is rotatable around a rotation axis along the horizontal direction relative to the arm 82. Besides, a motor (1F) for rotating the arm 83 relative to the arm 82 is installed in the arm 83.

The arm 84 is connected to a tip of the arm 83, and the arm 84 is rotatable around a rotation axis along the horizontal direction relative to the arm 83. Besides, a motor (1G) for rotating the arm 84 relative to the arm 83 is installed in the arm 84.

The arm 85 is connected to a tip of the arm 84, and the arm 85 is rotatable around a rotation axis along the center axis of the arm 84 relative to the arm 84. Besides, a motor (1H) for rotating the arm 85 relative to the arm 84 is installed in the arm 85.

The wrist 86 is connected to a tip of the arm 85. The wrist 86 includes a ring-shaped support ring 861 connected to the arm 85 and a cylindrical wrist body 862 supported at a tip of the support ring 861. A tip surface of the wrist body 862 is a flat surface and becomes a mount surface on which for example, a manipulator to hold a precision equipment, such as a wrist watch, is mounted.

The support ring 861 is rotatable around a rotation axis along the horizontal direction relative to the arm 85. Besides, the wrist body 862 is rotatable around a rotation axis along the center axis of the wrist body 862 relative to the support ring 861. Besides, a motor 1 (11) for rotating the support ring 861 relative to the arm 85 and a motor 1 (1J) for rotating the wrist body 862 relative to the support ring 861 are arranged in the arm 85. The driving forces of the motors 1I and 1J are respectively transmitted to the support ring 861 and the wrist body 862 by not-shown driving force transmission mechanisms.

As described above, according to the robot 8 of the embodiment, the effects of the motor 1 described above can be obtained. Besides, the highly reliable robot 8 can be provided.

Although the motors and the robots are described based on the illustrated embodiments, the invention is not limited to these, and the configuration of each part can be replaced by an arbitrary configuration having the same function. Besides, another arbitrary component may be added to the invention.

The entire disclosure of Japanese Patent Application No. 2015-029303, filed Feb. 18, 2015 is expressly incorporated by reference herein.

What is claimed is:

1. A motor comprising:
a stator core;
a plurality of bobbins mounted on the stator core and provided with flange parts; and
a winding wound around each of the bobbins; in which
a space of a gap between the plurality of flange parts adjacent to each other is smaller than a diameter of the winding.

2. The motor according to claim 1, wherein the space of the gap is larger than 0.2 mm and smaller than 0.3 mm.

3. The motor according to claim 1, wherein the gap between the plurality of flange parts adjacent to each other has a shape bent with respect to a radial direction of the stator core.

4. The motor according to claim 1, wherein the gap between the plurality of flange parts adjacent to each other has a shape widening in a radial direction of the stator core.

5. A robot comprising a motor according to claim 1.

6. A robot comprising a motor according to claim 2.

7. A robot comprising a motor according to claim 3.

8. A robot comprising a motor according to claim 4.
